(19) United States
(12) Patent Application Publication
(10) Pub. No.: US 2009/0033977 A1
(43) Pub. Date: Feb. 5, 2009

(54) METHOD AND SYSTEM FOR AGGREGATING PRINT JOBS

(75) Inventors: Javier A. Morales, Irondequoit, NY (US); Michael E. Farrell, Webster, NY (US); Nicholas P. Osadciw, Webster, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: XEROX CORPORATION, Stamford, CT (US)

(21) Appl. No.: 11/830,904

(22) Filed: Jul. 31, 2007

(51) Int. Cl. G06F 3/12

(52) U.S. Cl. 358/1.15

(57) ABSTRACT

A computer implemented method is provided for automatically aggregating multiple print jobs. The method includes: (A) combining first and second print jobs, each of which complies with a print processing related rule, and the combination of the first and second print jobs corresponds with a first print job size value; (B) receiving a third print job corresponding with a second print job size value; (C) aggregating the first, second and third print jobs into an aggregate print job when the third print job complies with the print processing related rule and a combination of the first, second and third print jobs results in an aggregate print job having a third print job size value that is less than a reference print job size value; and (D) producing a print output with the combination of the first print job and the second print job when the third print job complies with the print processing related rule and a combination of the first, second and third print jobs results in an aggregate print job having a fourth print job size value that exceeds the reference print job size value.

### CROSS-REFERENCE TO RELATED APPLICATIONS

Cross-reference is made to U.S. patent application Ser. No. ______ (Attorney Docket No. 20070201-US-NP) that was filed on the same day as the present application by the same assignee with the same title, and to U.S. patent Ser. No. ______ (Attorney Docket No. 20070570-US-NP) that was filed on the same day as the present application by the same assignee with the same title.

### BACKGROUND AND SUMMARY

The disclosed embodiments relate generally to a method for processing print jobs and, more particularly, to an approach in which two or more print jobs are automatically aggregated for submission to a print engine.

Creation and production of printed documents often involves many production and finishing operations that are highly variable with each job. In general, the various operations can be grouped into three major phases: 1) creation of the document information, including prepress operations that render the document in a form suitable for printing, 2) printing of the information onto some form of media such as paper, and 3) finishing of the selected media into a completed document. These 3 major phases often have many sub-phases, and the entire process may vary from relatively simple to extremely complex.

U.S. Pat. No. 6,462,756 B1 to Hansen et al. discloses a system and method for managing production printing workflow. The system includes workflow management software for managing and facilitating the procedural stages of the workflow including job origination, job preparation, job submission and job fulfillment. The workflow management software provides an integrated object oriented interface which visually reflects and interacts with the workflow. The software further provides functionality for efficient page level modifications to documents at the job preparation stage. This functionality allows such modifications to be easily made to selected pages and visually verified by displaying visual representations of the modifications on visual representations of the pages.

U.S. Pat. No. 7,092,963 B2 to Ryan et al. discloses a print production and finishing system for electronic management and control of a wide range of finishing processes characterized by input from multiple production operations and equipment that, depending upon the job, might be variably applied to work pieces that themselves are highly variable between different jobs. The disclosed embodiments of the '963 patent are applicable to many operations where processes for production of work pieces are managed separately from processes for finishing and packaging of such work pieces.

As digital print increasingly becomes a commodity, printers increasingly look for ways to cut costs. One known way of cutting cost is to print a job calling for a first media size on a second, larger media size, and then cutting the job to obtain an output with the first media size. To achieve this, imposition can be used to print multiple pages on each sheet and a stack can be cut at a suitable cutting device to achieve the desired output. In one example, a job with letter size media would be printed in two up format on ledger size paper, and the ledger size paper would be cut in half to obtain letter sized output. While this approach can be very effective for cutting cost, particularly when employed with jobs of significant length, the same approach does not necessarily achieve desired cost savings when used to process a large number of relatively smaller jobs are to be processed. Printing relatively smaller jobs on larger media and then cutting the larger media can create more finishing than is economical for a corresponding bindery.

At least three related references, namely U.S. Pat. Nos. 6,650,433; 7,133,149; and 7,187,465 are concerned with aggregating print jobs. In one disclosed approach, jobs may be aggregated as follows:
The prepress aggregation module, a rules-based program, aggregates print jobs by scanning the Ordered Items table of the central database and searching for items (print jobs) that have the same printing requirements, e.g., the same delivery date, paper grade, and post press processing requirements. Scanning generally continues until enough print jobs have been located to fill a layout of a given size. The XML files corresponding to the selected print jobs are then pulled from the Document Table, converted to PostScript files and aggregated, as discussed above.

This approach aggregates jobs relative to a “layout” and thus appears to possess some of the same possible shortcomings as the previously discussed prior art approaches. That is, printing relative to a layout can lead to the same kind of uneconomical finishing costs encountered with cutting over-sized sheets.

The pertinent portions of all of the above-mentioned patents are incorporated herein by reference.

In accordance with a first aspect with the disclosed embodiments there is disclosed a computer implemented method of automatically aggregating multiple print jobs, comprising: (A) combining a first print job and a second print job, wherein each one of the first print job and the second print job complies with a print processing related rule, and wherein the combination of the first print job and the second print job corresponds with a first print job size value; (B) receiving a third print job, the third print job corresponding with a second print job size value; (C) aggregating the first, second and third print jobs into an aggregate print job and storing the aggregate print job in memory when the third print job complies with the print processing related rule and a combination of the first, second and third print jobs results in an aggregate print job having a third print job size value that is less than a reference print job size value; and (D) producing a print output with the combination of the first print job and the second print job when the third print job complies with the print processing related rule and a combination of the first, second and third print jobs results in an aggregate print job having a fourth print job size value that exceeds the reference print job size value.

In accordance with a second aspect of the disclosed embodiments there is disclosed computer implemented method of automatically aggregating multiple print jobs, comprising: (A) creating a first aggregate print job representation corresponding with a combination of at least a first print job and a second print job, each one of the first and second print jobs complying with a print processing related rule; (B) storing the first aggregate print job representation at a first time, the combination of the at least two print jobs corresponding with a first print job size value; (C) receiving, at a second time, a print job representation corresponding with both a third print job and a second print job size value; (D) determining whether (1) the print job representation complies with the print processing related rule, and (2) a combination of the first aggregate print representation and the print job representation corresponds with a combined print job size value that is less than or equal to a selected threshold; (E) creating a second aggregate print job representation, including the combination of the first aggregate print representation and the print job representation, and storing the second aggregate print job representation in memory when it is determined, with said (D), that compliance with the print processing related rule exists and the combined print job size value is less than or equal to the selected threshold; and (F) producing a print output, with the first aggregate print job representation when it is determined, with said (D), that compliance with the print processing related rule exists and the combined print job size value is greater than the selected threshold.

In accordance with a third aspect of the disclosed embodiments there is disclosed a computer implemented print job aggregation system, comprising: (A) a combination of a first print job and a second print job, wherein each one of the first print job and the second print job complies with a print processing related rule, and wherein the combination of the first print job and the second print job corresponds with a first print job size value; and (B) a computer-readable storage medium containing one or more programming instructions for performing a computer implemented method of automatically aggregating multiple print jobs, comprising: (1) receiving a third print job, the third print job corresponding with a second print job size value, (2) aggregating the first, second and third print jobs into the aggregate print job and storing the aggregate print job in memory when the third print job complies with the print processing related rule and a combination of the first, second and third print jobs results in an aggregate print job having a third print job size value that is less than a reference print job size value, and (3) producing a print output with the combination of the first print job and the second print job when the third print job complies with the print processing related rule and a combination of the first, second and third print jobs results in an aggregate print job having a fourth print job size value that exceeds the reference print job size value.

### BRIEF DESCRIPTION OF THE DRAWINGS

FIG. 1 is a block diagram of a document processing workflow including a production monitor controller (PMC), the workflow being suitably configured for use with the disclosed embodiments;

FIG. 2 is a block diagram emphasizing selected aspects of the workflow of FIG. 1, including the PMC with various inputs and outputs, such as a virtual job ticket database (VJTDB);

FIG. 3 is a planar view of a job segment identifier sheet;

FIG. 4 is a flowchart illustrating a computer implemented approach for aggregating print jobs; and

FIG. 5 a schematic diagram illustrating how three jobs might be combined over time.

### DESCRIPTION OF DISCLOSED EMBODIMENTS

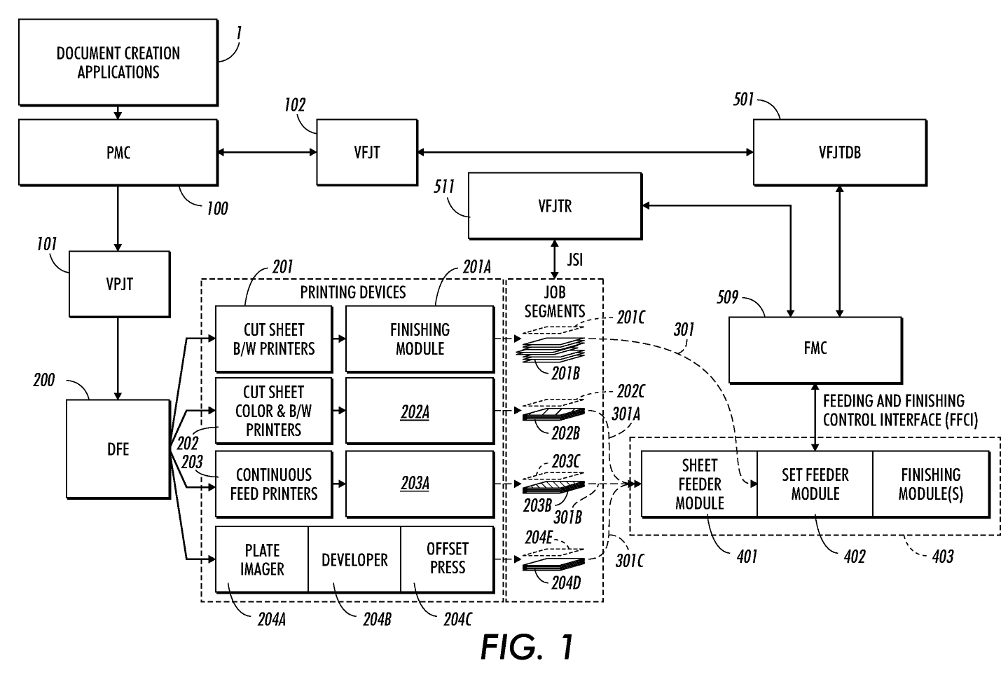

Turning now to FIG. 1, an overview of a workflow suitable for use with disclosed embodiments is shown. Within FIG. 1, box 1 represents prepress operations, and the output of the prepress operations of box 1 is a set of appropriate PDL files that are delivered to a Production Monitor Controller (PMC), 100. As described more fully below, the PMC is a controller that coordinates overall production of the print job.

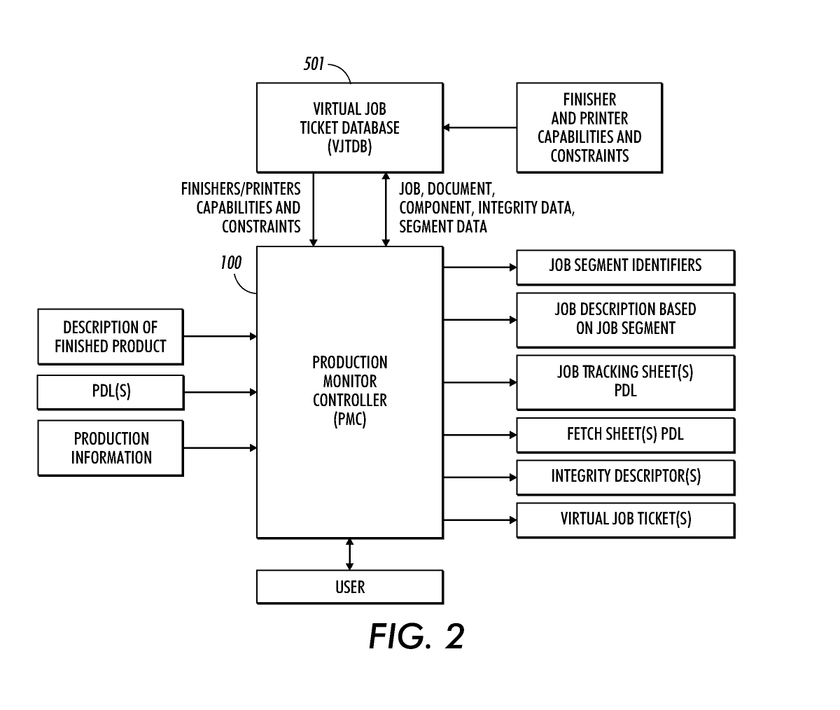

FIG. 2 shows some exemplary inputs and outputs of the PMC 100, as well as the relationship between the PMC and a virtual finishing job ticket database (VFJTDB) 501. In general, the inputs to the PMC 100 include some or all of: 1) from the Virtual Printer Job Ticket Database (“VPJTDB”), a list of printer capabilities and constraints; 2) from the VFJTDB, a list of assembler/finisher capabilities and constraints; 3) a description of the finished product which may be a CIP3 or similar description; 4) PDLs and other files for the content to of each sheet to be printed; 5) production information such as the number of copies, targeted printing devices, and any special finishing or packaging attributes, including, without limitation, the identity and retrieval location of any non-printed and/or inventory items. In general, the output from the PMC includes identification of each job segment for each operation within the job as well as a set printing and assembling/finishing instructions for each job segment. More specifically, the output from a PMC comprises some or all of: 1) a job segment descriptions and identifiers for each job segment; 2) a database representation (such as the VJTDB description explained below) of the structure of the job segments and the document components, sheets or sets within the job segment; 3) a PDL file for a job tracking sheet, if any; 4) a PDL for a fetch sheet, if any; 5) integrity descriptors encoded into the VFJTDB for later use by a Finishing Module Coordinator (FMC); 6) virtual job tickets for printers and Assembler/finishers; and 7) a prompt to call for one or more human operator responses.

Referring again to FIG. 1, the instruction set for printing and assembling/finishing is output from PMC 100 in the form of both a Virtual Print Job Ticket (VPJT), 101, and a Virtual Finishing Job Ticket (VFJT), 102. The VFJT and VPJT may contain the complete instruction set for the job or may simply contain reference pointers to a database where such information is retained. The VPJT 101 is conventional in the art as discussed in relation to U.S. Pat. Nos. 5,995,721 to Rourke et al., 5,615,015 to Krist et al., and 5,760,775 issued to Sklot.

The data for each VFJT is recorded by the PMC in the VFJTDB shown in FIG. 1 as 501. In one example, the VFJTDB is a database or a data file that contains all job construction, control and integrity data necessary to take the prints coming from the printing device(s) and perform the necessary finishing processes to turn the prints into the desired final output form. The format of the VFJTDB can be hard copy (print), soft copy (floppy, CD-R, CR-RW) or electronic (electronically stored in memory or on a hard disk drive) copy form. The format may be one or both of human and machine-readable.

The type of data and instructions required in a VFJTDB 501 for each job are information such as but not limited to: accounting and administration information, sheet, set and job level finishing instructions, color and print quality control data, registration data, etc. The data and instructions also contain a description of the job segments (stacks and stacks of sets) of the job being produced and instructions on how to reassemble these pieces to complete the processing of the job. Additionally this information can enable the automatic setup of the finishing device(s), integrity control and monitoring throughout the full scope of the production processes. The VFTDB provides the basis for a direct link between the offline finishing operations and the integrity control functions of online printing and intermediate finishing systems. The VFJTDB data can take on the form of a proprietary format or an industry standard format such as but not limited to a modified form of CIP3.

Referring still to FIG. 1, the printing process may be commenced after delivery of the VPJT, 101, to one or more Digital Front End Print Controllers (DFE) represented by box 200. Such DFE's are conventional in the art. Examples include PDL products made by Splash, Harlequin, Adobe, and others. In conformance with instructions provided in the VPJT, 101, the print job is divided into separate printing job segments and is distributed to various print engines for printing using the printer or press which the operator or PMC, 100, believed to be optimal when the VPJT was first established. Alternatively, the VPJT may provide that the DFE, 200, sometimes through interaction with the PMC, 100, may automatically select the appropriate printing device based upon dynamic queue and print selection criteria.

Boxes 201-204 of FIG. 1 are examples of various types of printers to which document components may be delivered for printing. Printer 201 may be a cut sheet digital printer connected to an integrated finishing module 201A. Integration between printer 201 and finisher module 201A is accomplished using DFA or MFFA-type protocols. As discussed above, a typical finisher module 201A includes capabilities such as collation, folding, and simple binding such as stapling. Printer 202 may be a cut sheet printer with a combination of color and monochrome printing capability. The Document Centre® Color Series 50 printer sold by Xerox Corporation is such a printer. Finisher module 202A is integrated with printer 202 as shown in FIG. 1 and may have capabilities similar to those described in connection with finisher 201A. Similarly, printer 203 is shown as a continuous form feed printer and is integrated with finisher module 203A. Printer 204 represents the various apparatus and processes normally associated with offset printing, including the prepress steps of preparing offset plates at a plate imager 204A, plate developer processor 204B, and offset printing press 204C. Unlike printers 201-203, which may be digitally integrated with their respective intermediate finishing modules 201A-203A, offset presses are not digital imaging devices and lack direct digital integration with assembly and finishing equipment.

As shown in FIG. 1, each of finishing modules 201A-203A and offset press 204C place their respective job segments in their respective output trays or bins 201B-203B and 204D. When placed in such trays or bins, the job segments or may not be collated, stacked or otherwise separated for handling and conveyance. Also each of finishing modules 201A-203A may provide some intermediate level of finishing, such as folding or stapling. Multiple document components may be printed or assembled at the same printer and intermediate finishing station and be treated during this phase of the job as one job segment. Conversely, a single large document component may be output in a stack with separator sheets or offset stacks indicating multiple job segments within the single document component.

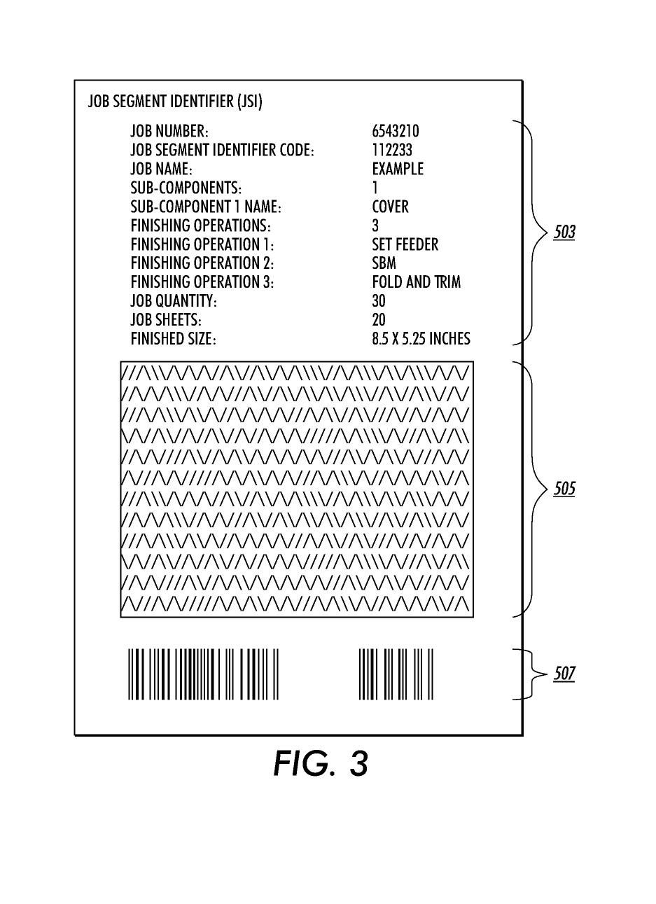

Referring to FIGS. 1 and 3, another aspect of the disclosed embodiments is the association of a unique Job Segment Identifier (JSI) with each job segment. In FIG. 1, a sheet containing a JSI is shown in association with each job segment that is output from printers 201-204. The respective JSI sheets are labeled 201C-203C and 204E, respectively. For complex jobs or for document components that are printed in large stacks, there may be many JSIs corresponding to many job segments within the job or within the stacks.

A JSI can assume any form that can be associated with a job segment throughout the finishing and other applicable printing processes. Among such forms are copies stored in (a) a printed sheet printed and placed on top of a printed job segment, (b) system memory such as hard drives, (c) magnetic media such as floppy disks or magnetic strips, (d) optical memory such as CD-ROM or CR-RW disks, (e) bar code symbols printed on sheets associated with the Job Segment, or (f) any other means by which machine or human readable identifying information may be associated with a Job Segment. A JSI may be machine, human readable, or both depending upon the phase of the job. Indeed, in the event that a scanner is capable of reading the top printed page of a job segment in such manner that the job segment can be uniquely identified, then no special symbols or special top page would be necessary. Thus, each JSI contains, as a minimum, a job and job segment number or other identifier that uniquely identifies the job segment from all other job segments. Typically, the JSI comprises both a unique job number and a Job Segment Identifier Code (JSIC). The job number uniquely identifies the print job from all other print jobs and the JSIC uniquely identifies the job segment. In one embodiment, the JSIC comprises recognizable unique text on the top sheet of a job segment, which JSIC forms a vector to a JSI that remains encoded in digital memory. Whichever form a JSI takes, the JSI serves as a reference pointer to the portion of the VFJTDB that describes the contents of the identified job segment. The JSI remains associated with the applicable job segment when it is transported from the printing device(s) to other finishing processes. This enables tracking of the job segment from the printing device(s) to the assembler/finisher apparatus. Whether or not the job segments are part of a job that requires prints to be produced on one or more printing device(s), each JSI will have a common job number but a different JSIC that uniquely identifies each particular job segment of the job.

In FIG. 1, the JSIs are shown in the form of a printed sheet called a Job Segment Identifier Sheet (JSIS) that is typically printed along with the sheets of the job and is placed on top of the job segment stack in the output trays or bins, 201B-203B and 204D. Such JSIS sheets are shown in FIG. 1 as 201C-203C and 204E. Information on a JSIS comprises either (a) a pointer (the job number and JSIC) to VFJTDB stored in some other electronic or soft copy format or (b) the portion of the VFJTDB itself that provides instructions for the job. Such instructions may be printed on the JSIS in electronic or human readable form. In contrast to conventional separator sheets that are placed upon each stack of printed output no matter how large the stack, each JSI serves as a unique identifier of each job segment of a print job.

Referring to FIG. 3, an example of a JSIS is shown. Human readable text comprising the JSI and job instructions is shown at region 503. In region 505, machine readable glyphs are shown containing the full data content of the VFJTDB applicable to the identified job segment. In region 507, a machine readable bar code is shown which comprises a pointer to the VFJTDB stored elsewhere.

In the final assembly and finishing phase, the various document components are gathered from output trays or bins 201B-203B and 204D, assembled in a particular order, and finished into a specified document form. In FIG. 1. arrows 301 and 302A, B, and C show the conveyance of printed job segments from output trays or bins 201B-203B and 204D to finishing Set Feeder Module 402 and Sheet Feeder Module 401, respectively.

As contemplated by the disclosed embodiments, each job segment arrives at the assembler/finisher apparatus with a JSI reference pointer. As noted above, this typically will appear on a JSIS although any form of JSI will suffice. The purpose of the JSI is to identify a particular job segment to a Finishing Module Coordinator (FMC) 509, which is a controller suitable for directing the assembler/finisher operations. In FIG. 1, a Virtual Finishing Job Ticket Reader (VFJTR) is shown as 511 and is responsible for reading the JSIS or for otherwise providing information to the FMC, 509, sufficient for the FMC to determine the unique JSIC. Humans may also intervene in the process to submit JSICs to the FMC, particularly if a JSIS is only human readable. The FMC, 509, is a software-based controller that manages, interprets, sequences, and allocates assembler/finisher production data. Using a variety of interfaces to each assembler/finisher device, the FMC communicates to each device the data required to program that device for implementation of the job. It tracks each job segment through the process and ensures that job segments are properly loaded before the devices begin operating.

The FMC also typically provides information to human operators concerning job status and in order to enable operators to make production decisions where necessary or appropriate. The FMC operates by receiving the JSI that identifies each job segment and determining whether the JSI itself contains all required assembler/finisher data. If a JSIS or similar JSI does not provide all instructions for finishing the job, then the FMC uses the JSIC to retrieve all relevant information concerning the job model stored in the VFJTDB. The FMC then reviews the assembler/finisher combinations prepared by the PMC to ensure that all identified devices are currently available. Once this condition is satisfied, then the FMC determines the bins or other assembler/finishing locations where each job segment should be placed. In general, the FMC communicates with the PMC through the VFJTDB. Where assembler/finisher devices are automatically programmable, the FMC may be programmed to interact with the specified interface format for each device in order to automatically provide programming instructions. Job tracking and integrity information would also be provided. When all required job segments have been loaded in their appropriate bins, the FMC would either direct the assembler/finisher devices to begin or would inform human operators that the job is ready. In this manner, the complete assembler/finisher operation can be controlled, implemented, tracked, and checked for integrity.

Further detailed description regarding structure and operation associated with FIGS. 1-3 is provided in U.S. Pat. No. 7,092,963 B2 to Ryan et al., the pertinent portions of which are incorporated herein by reference.

The following is an overview of an embodiment for aggregating print jobs: In a print job aggregating embodiment, the above-described system would be provided with rules for determining what type of jobs should be aggregated together. For example, when disposed in an aggregation mode, the system might aggregate all incoming letter-sized documents together. In support of the mode, the system would possess instructions regarding the formation and processing of aggregate jobs. Additional instructions might be directed to, among other things, imposing all letter-sized aggregate jobs in 2-up format on 11×17 print media.

Pursuant to management of aggregate jobs, a user might set a destination for the job. The destination might be used to define aggregation boundaries. For example, if the aggregate job was set to be processed with a given stacking device, the system would be provided information about the capacity of such stacking device. This capacity, along with a desired print quantity, could then be used to determine the number of single jobs to be combined into an aggregate job. This would ensure maximum use of the stacker, while ensuring that each stack of paper contains a contiguous set of print jobs.

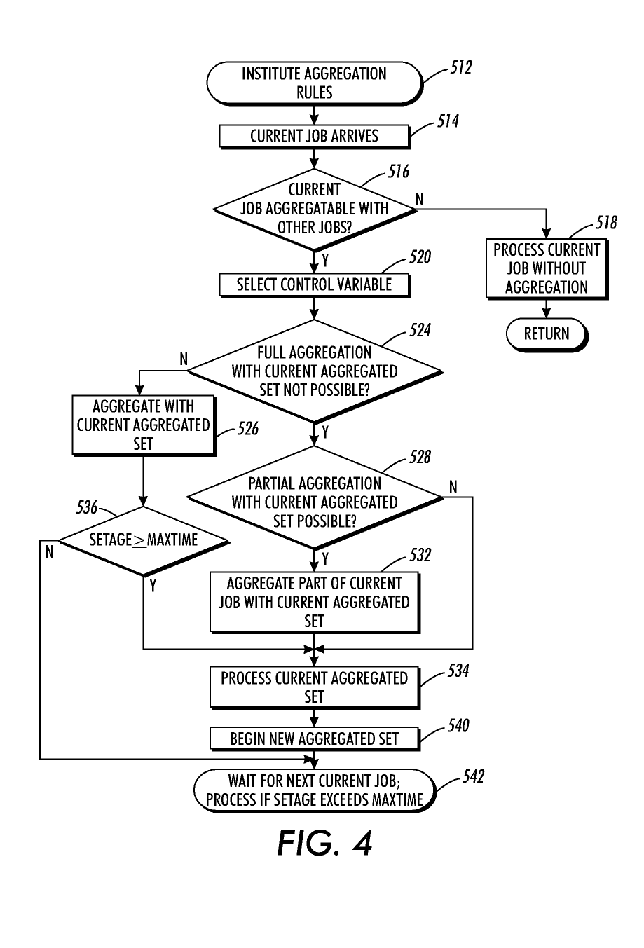

Referring to FIG. 4, an exemplary computer implemented approach for aggregating print jobs is described. Initially, at 512, a set of aggregation rules is provided. While letter size, as mentioned above, may be used as one criteria for aggregation, there are many criteria that will appear to those skilled in the art, including media type (size, weight, or color), printing system color, gloss, grain, opacity, desired image quality, just to name a few. As each job arrives (514), the current job may be assessed (516) to determine if it is aggregatable with other stored jobs. Each non-aggregatable job is processed in a normal course (518), while, at 520, a control variable for aggregation is selected. One control variable might include job size, As can be appreciated by those skilled in the art, “job size” can be defined in several contexts. For instance, job size could refer to a “quantity of sets,” or “a first quantity of pages per set multiplied by a second quantity of sets,” just to name a few. Other control variables, such as job age, are contemplated by the disclosed embodiments. A plurality of control variables may be applied.

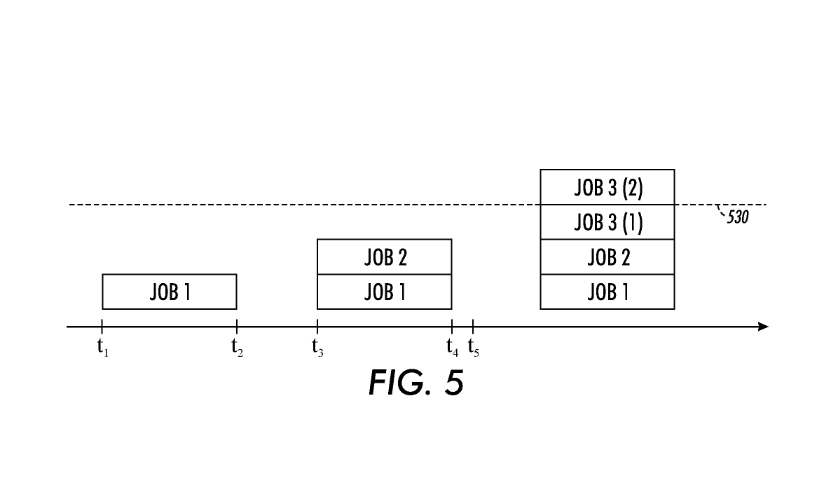

At 524, a determination as to whether all of the current job can be aggregated with a combination of stored jobs is made. If the entire current job is aggregatable, then the aggregation of 526 is performed; otherwise, at 528, a second level determination, regarding partial aggregation, is made. Referring briefly to FIG. 5, a concept of full or partial aggregation is described. As shown, Job 2 can be completely aggregated with Job 1 because a combination of the two jobs does not exceed a given threshold 530. In a first example, the threshold 530 corresponds with an output constraint, such as the page capacity or size of an output device (such as an output stacker or finishing device). As can be appreciated by those skilled in the art, output constraints can correspond to physical constraints or characteristics of the hardware devices used in production or they may correspond to less tangible concepts such as shop policies. For instance, the threshold 530 could be varied to reflect a job or container limit. Additionally, each of Job 1 and Job 2 can be placed in n-up format so that the number of printable pages for each job can be reduced considerably. In one approach, letter size pages are imposed electronically on 11×17 media, and, pursuant to finishing, cut and stack operations can be performed to return the aggregate job to its original intended components.

In one example, Job 3 (a combination of Job 3(1) and Job 3(2)) cannot be completely aggregated with the current aggregate job (including Jobs 1 and 2) because the combination of Jobs 1, 2 and 3 exceed the threshold 530. In this event, Job 3 can either be excluded from the current aggregate job, and the current aggregate job processed by the system, or a part of Job 3 (Job 3(1) in the example of FIG. 5) can be aggregated with the current aggregate job or set (532 of FIG. 4) and a current aggregated set of Job 1, Job 2 and Job 3(1) can be processed (534). It should be appreciated that Job 3 is most easily divided along set boundaries (if they exist) and that, in the absence of a convenient boundary along which to divide Job 3, it might be undesirable to aggregate even part of Job 3 with Jobs 1 and 2. In the event that aggregation of partial Job 3 is undesirable, Jobs 1 and 2 are simply processed without any of Job 3.

As contemplated, permitting a given aggregate job to exceed a select age is undesirable. Consequently, referring to FIG. 4, when a maximum storage age (“Maxtime”) of an aggregate job or set exceeds the storage age (“Setage”) of the aggregated set (536), then the current aggregate job is processed (via 534). Referring again to FIG. 5, the exemplary approach of processing an aggregate job on the basis of age can be further understood. In particular, after aggregating the jobs at t₄, a check (536 of FIG. 4) may be performed at t₅. Assuming t₅ is greater than Maxtime, then the aggregate of Jobs 1 and 2 is processed via 534.

Referring now to FIGS. 4 and 5, for the example in which Job 3(1) is combined with Jobs 1 and 2, a new aggregation set (including Job 3(2)) is begun at 540. Then the system waits (542) for the next job to determine, by way of 516, whether it can be aggregated with Job 3(2). Referring still to 542, for those instances in which aggregate jobs are not permitted to age past a given Maxtime, the check of 536 is performed periodically for the current aggregate set.

Elaborating just a bit further on the above description, if the page count of a given set of jobs (or “aggregation group”) exceeds the capacity of a given output device, the system will proceed to process all but the last job in the aggregation group (“AG”). A part of the last job (possibly one or more job sets defined by set boundaries) may be processed with all but the last job. The last job, or part of the last job, may then become the first job of the next aggregation set. Other potential variables for aggregation could include print quantity. This could be used in a couple of different ways. For instance, thresholds for aggregating could be set at less than n sets. Also, an incoming job could be aggregated with an existing AG and a determination could be made as to whether the job fits as a part of the existing AG or constitutes the start of a new AG. If the job does not fit the system might start a new AG but keep the old AG open for additional jobs. Jobs would then be fit into an AG by looking at the oldest AG first and only looking at a further AG if the job does not fit in the oldest AG. As contemplated by the disclosed embodiments, a given AG would only be stored for a selected time interval—after the selected time interval, the given aggregated AG would be transmitted to an output device for processing. As is also contemplated by the disclosed embodiments, time values (such as the end of a second of two shifts) or setbacks from production relevant time events (such as a courier pickup time) can also be used to trigger the transmission of an aggregated AG to the output device.

The above-described approach may even be more fully understood by reference to the following example:
a. Evaluate a job against one of several aggregation rules (e.g., Is the job letter size? Does the job conform with the requirements of a target processing device, such as image quality requirements?
b. If the job matches an aggregation rule, the system holds it and inspects the print quantity and number of pages in the job. This determines the number of pages required to print the job.
c. This number of pages may be evaluated against imposition rules and against output device capacity (such as output stacker capacity). For example, 50 copies of a job including 100 pages to be printed in duplex will require 2500 pages. Furthermore, if the imposition rules state that the job will be imposed 2-up, the system will determine that printing the job requires 1250 larger sheets. The number of sheets required by this job is added to the total number of sheets required by all the jobs currently held in aggregation.
d. The system then determines whether the total number of sheets required by all jobs currently held in aggregation exceeds a given control variable (such as the capacity of a select output device). If the quantity does not exceed the control variable, the system will wait for another job to aggregate.
e. For those instances where jobs being considered for aggregation are of the same page description language (PDL) type, the subject aggregation approach can be performed prior to rasterization. On the other hand, performing the approach with respect to rasterized jobs permits seamless aggregation of jobs with heterogeneous PDLs.
f. If the quantity exceeds the capacity of the output device, the system will proceed to process all but the last job in the aggregation set. As mentioned above, a part of the last job (possibly one or more job sets defined by set boundaries) may be processed with all but the last job. The last job, or part of the last job, will then become the first job of the next aggregation set.
g. Once the aggregate job is released to processing, the system concatenates all jobs in the aggregation set and, in one example, employs cut & stack imposition.
h. The above-mentioned concatenation may be achieved using one of any known mechanisms for placing content on a job. For example:
   1. Creating a new job that contains all jobs in the aggregation set.
   2. Creating a new job (PS, PDF or even VI) that uses file references as pointers to pages.
   3. Creating a new job that uses dynamic document assembly (e.g. DocuSP (“DocuSP” is a trademark of Xerox Corporation) post-RIP assembly)).
i. In those cases where jobs are aggregated prior to rasterizing, the aggregated PDL may contain multiple references corresponding respectively with the jobs of the aggregated set. That is, the aggregated job might contain a reference for each copy of an input job. The aggregated job will then be printed once but each job in the aggregated set will be repeated enough times to ensure that the desired quantity is printed and that all printed sets are contiguous.
j. Once the job is imposed, it can be printed normally. The bindery operator would then separate (cut) the imposed stacks and reconstitute (via s simple stack operation) the original print order as bindery operator would for any job imposed via Cut & Stack imposition.
k. The system might optionally be configured to release aggregated jobs based on other rules. For example, the system might release the aggregated jobs when the oldest job in the set reaches a certain age. Alternatively, the system might be configured to release the stack based on the capacity of finishing devices.

Based on the above description, the following features of the disclosed embodiments should now be apparent:
In one example, the disclosed process may include configuring a print processing related rule to require that each print job to be aggregated comply with a select print media attribute value. This may include aggregating first, second and third print jobs into an aggregate print job and storing the aggregate print job in memory when (a) each page of the first, second and print jobs corresponds with a size of 8.5 inches by 11 inches, and (b) the fourth print job size value is less than a reference print job size value. Alternatively, the disclosed process might include configuring the print processing related rule to require that each print job to be aggregated comply with an image quality attribute.
In another example, a print output is produced with a stored aggregate print job when or after a select event occurs. In one example, where the print output is to be picked up by a courier at a designated time, production of the stored aggregate print job occurs prior to the designated time. In another example, where a production “shift” ends at a given shift end time, production of the stored aggregate print job occurs prior to the given shift end time.
In yet another example, the reference print job size value is corresponded with an output device.
In yet another example, a print output is produced from a combination of the first and second print jobs, along with a portion of the third print job when the third print job complies with a print processing related rule and a print job size value corresponding with a combination of the first print job, the second print job and the portion of the third print job does not exceed the reference print job size value. In one instance, the portion of the third print job comprises a first portion, and the third print job may be divided along a boundary to form the first portion and a second portion. Finally, the second portion may be used in forming a second aggregate print job.
In yet another example, each one of the first, second and third print jobs are rasterized prior to forming an aggregate print job from the same.
In yet another example, a combination of the first, second and third print jobs may be produced, as a print output, when or after a selected amount of time has transpired.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A computer implemented method of automatically aggregating multiple print jobs, comprising:
(A) combining a first print job and a second print job, wherein each one of the first print job and the second print job complies with a print processing related rule, and wherein the combination of the first print job and the second print job corresponds with a first print job size value;
(B) receiving a third print job, the third print job corresponding with a second print job size value;
(C) aggregating the first, second and third print jobs into an aggregate print job and storing the aggregate print job in memory when the third print job complies with the print processing related rule and a combination of the first, second and third print jobs results in an aggregate print job having a third print job size value that is less than a reference print job size value; and
(D) producing a print output with the combination of the first print job and the second print job when the third print job complies with the print processing related rule and a combination of the first, second and third print jobs results in an aggregate print job having a fourth print job size value that exceeds the reference print job size value.

2. The method of claim 1, in which each print job corresponds with a print media attribute value, further comprising configuring the print processing related rule to require that each print job to be aggregated, per said (C), comply with a select print media attribute value.

3. The method of claim 2, wherein said (C) includes aggregating the first, second and third print jobs into the aggregate print job and storing the aggregate print job in memory when (a) each page of the first, second and print jobs corresponds with a size of 8.5 inches by 11 inches, and (b) the third print job size value is less than the reference print job size value.

4. The method of claim 1, in which each print job corresponds with an image quality attribute value, further comprising configuring the print processing related rule to require that each print job to be aggregated, per said (C), comply with an image quality attribute value.

5. The method of claim 1, further comprising producing a print output with the aggregate print job when or after a select event has occurred.

6. The method of claim 5, in which the print output is to be picked up by a courier at a designated time, wherein said producing when or after a select event has occurred comprises producing the print output prior to the designated time.

7. The method of claim 1, further comprising corresponding the reference print job size value with a capacity of an output device.

8. The method of claim 1, wherein said (D) further includes producing a print output with (a) the combination of the first print job and the second print job, and (b) a portion of the third print job when the third print job complies with the print processing related rule and a print job size value corresponding with a combination of the first print job, the second print job and the portion of the third print job does not exceed the reference print job size value.

9. The method of claim 8, in which the portion of the third print job comprises a first portion, further comprising dividing the third print job along a boundary to form the first portion and a second portion.

10. The method of claim 9, in which a combination of the first and second print jobs comprises a first aggregate print job, further comprising:
(E) using the second portion of the third print job in forming a second aggregate print job.

11. The method of claim 1, further comprising rasterizing each one of the first, second and third print jobs prior to performing said (C).

12. The method of claim 1, further comprising producing a print output with the aggregate print job when or after a select amount of time has transpired.

13. A computer implemented method of automatically aggregating multiple print jobs, comprising:
(A) creating a first aggregate print job representation corresponding with a combination of at least a first print job and a second print job, each one of the first and second print jobs complying with a print processing related rule;
(B) storing the first aggregate print job representation at a first time, the combination of the at least two print jobs corresponding with a first print job size value;
(C) receiving, at a second time, a print job representation corresponding with both a third print job and a second print job size value;
(D) determining whether (1) the print job representation complies with the print processing related rule, and (2) a combination of the first aggregate print representation and the print job representation corresponds with a combined print job size value that is less than or equal to a selected threshold;
(E) creating a second aggregate print job representation, including the combination of the first aggregate print representation and the print job representation, and storing the second aggregate print job representation in memory when it is determined, with said (D), that compliance with the print processing related rule exists and the combined print job size value is less than or equal to the selected threshold; and
(F) producing a print output, with the first aggregate print job representation when it is determined, with said (D), that compliance with the print processing related rule exists and the combined print job size value is greater than the selected threshold.

14. The method of claim 13, in which each print job corresponds with a print media attribute value, further comprising configuring the print processing related rule to require that each print job to be aggregated corresponds with a select print media attribute value.

15. The method of claim 13, further comprising producing a print output with the second aggregate print job when or after a select event has occurred.

16. The method of claim 15, in which the print output is to be picked up by a courier at a designated time, wherein said producing when or after a select event has occurred comprises producing the print output prior to the designated time

17. The method of claim 13, producing the print output with (a) the combination of the first print job and the second print job, and (b) a portion of the third print job when the third print job complies with the print processing related rule and a print job size value corresponding with a combination of the first print job, the second print job and the portion of the third print job does not exceed the selected threshold.

18. The method of claim 13, further comprising corresponding each of the first, second and third print jobs with a common page description language.

19. The method of claim 13, further comprising rasterizing each one of the first, second and third print jobs prior to performing said (D).

20. The method of claim 13, further comprising producing a print output with the first aggregate print job when or after a select amount of time has transpired.

21. The method of claim 13, further comprising:
(G) corresponding the selected threshold with a capacity of an output device.

22. A computer implemented print job aggregation system, comprising:
(A) a combination of a first print job and a second print job, wherein each one of the first print job and the second print job complies with a print processing related rule, and wherein the combination of the first print job and the second print job corresponds with a first print job size value; and
(B) a computer-readable storage medium containing one or more programming instructions for performing a computer implemented method of automatically aggregating multiple print jobs, comprising:
(1) receiving a third print job, the third print job corresponding with a second print job size value,
(2) aggregating the first, second and third print jobs into the aggregate print job and storing the aggregate print job in memory when the third print job complies with the print processing related rule and a combination of the first, second and third print jobs results in an aggregate print job having a third print job size value that is less than a reference print job size value, and
(3) producing a print output with the combination of the first print job and the second print job when the third print job complies with the print processing related rule and a combination of the first, second and third print jobs results in an aggregate print job having a fourth print job size value that exceeds the reference print job size value.

23. The computer implemented print job aggregation system of claim 22, in which each print job corresponds with a print media attribute value, wherein the computer-readable instructions further include configuring the print processing related rule to require that each print job to be aggregated corresponds with a select print media attribute value.

24. The computer implemented print job aggregation system of claim 22, wherein a print output is produced with the aggregate print job when or after a select event has occurred.

25. The computer implemented print job aggregation system of claim 22, wherein the computer-readable instructions further include corresponding the reference print job size value with a capacity of an output device.

26. The computer implemented print job aggregation system of claim 22, wherein the computer-readable instructions further include producing a print output with (a) the combination of the first print job and the second print job, and (b) a portion of the third print job when the third print job complies with the print processing related rule and a print job size value corresponding with a combination of the first print job, the second print job and the portion of the third print job does not exceed the reference print job size value.

27. The computer implemented print job aggregation system of claim of 22, wherein the computer-readable instructions further include producing a print output with the aggregate print job when or after a select amount of time has transpired.
